(19) United States
(12) Patent Application Publication
(10) Pub. No.: US 2026/0045725 A1
(43) Pub. Date: Feb. 12, 2026

(54) Connector

(71) Applicant: Yazaki Corporation, Tokyo (JP)

(72) Inventors: Yuuhei Takeshita, Makinohara-shi (JP); Koki Iwakura, Makinohara-shi (JP); Yasuo Shimizu, Makinohara-shi (JP); Toshikazu Yoshioka, Makinohara-shi (JP); Moeto Osawa, Fujieda-shi (JP)

(21) Appl. No.: 19/290,561

(22) Filed: Aug. 5, 2025

(30) Foreign Application Priority Data
Aug. 7, 2024 (JP) 2024-130798

(51) Int. Cl. H01R 13/424

(52) U.S. Cl. CPC H01R 13/424

(57) ABSTRACT

A connector includes: a housing that includes a cavity extending in a first direction; a terminal that is connected to an end portion of an electric wire and inserted into the cavity; and a spacer that includes a proximal end portion, a lock portion extending from the proximal end portion in a second direction intersecting the first direction, and a rib portion disposed to be arranged in the first direction with the lock portion and extending from the proximal end portion in the second direction, wherein the spacer has the lock portion engaged with the housing to restrict the movement of the terminal with respect to the housing in the first direction, and even when the proximal end portion is pushed in the first direction by the terminal when the electric wire is pulled in the first direction, the lock portion comes into contact with the rib portion to restrict deflection of the lock portion and maintain engagement with the housing.

### BACKGROUND OF THE INVENTION

### Field of the Invention

An embodiment of the present invention relates to a connector.

The present application claims priority based on Japanese Patent Application No. 2024-130798 filed in Japan on Aug. 7, 2024, and the content thereof is incorporated herein.

### Description of Related Art

As a connector, connectors including spacers as disclosed in Japanese Unexamined Patent Application, First Publication No. 2017-45540 and Japanese p Unexamined Patent Application, First Publication No. H7-211381 are known.

### SUMMARY OF THE INVENTION

In the connectors disclosed in Japanese Unexamined Patent Application, First Publication No. 2017-45540 and Japanese Unexamined Patent Application, First Publication No. H7-211381, when the spacer is deformed when the electric wire is pulled, the engagement margin of the spacer decreases, and the terminal may come off from the housing.

One embodiment of the present invention provides a connector in which it is difficult for a terminal to come off from a housing.

A connector of one embodiment of the present invention includes: a housing that includes a cavity extending in a first direction; a terminal that is connected to an end portion of an electric wire and inserted into the cavity; and a spacer that includes a proximal end portion, a lock portion extending from the proximal end portion in a second direction intersecting the first direction, and a rib portion disposed to be arranged in the first direction with the lock portion and extending from the proximal end portion in the second direction, wherein the spacer has the lock portion engaged with the housing to restrict the movement of the terminal with respect to the housing in the first direction, and the lock portion and the rib portion have relative positions at which the lock portion deflected in the first direction comes into contact with the rib portion to restrict deflection of the lock portion and maintain engagement with the housing.

According to one embodiment of the present invention, it is difficult for the terminal to come off from the housing.

### BRIEF DESCRIPTION OF THE DRAWINGS

FIG. 1 is a perspective view illustrating a connector of an embodiment;

FIG. 2 is an exploded perspective view illustrating the connector of the embodiment;

FIG. 3 is a perspective view illustrating a housing and a spacer of the connector of the embodiment in a partial cross-sectional view;

FIG. 4 is a perspective view illustrating the spacer of the connector of the embodiment;

FIG. 5 is a front view illustrating the connector of the embodiment;

FIG. 6 is a cross-sectional view illustrating the connector of the embodiment; and

FIG. 7 is a cross-sectional view illustrating an operation of the spacer of the connector of the embodiment.

### DETAILED DESCRIPTION OF THE INVENTION

Hereinafter, an embodiment will be described with reference to the drawings. In the following description, constitutions having the same or similar functions are denoted by the same reference numbers. Then, redundant descriptions of these constitutions may be omitted. In the present disclosure, the terms are defined as described below. “Connection” is not limited to mechanical connection and may include electrical connection. That is, “connection” is not limited to a case where two elements to be connected are directly connected and may include a case where two elements are connected with another element interposed therebetween. “Parallel,” “orthogonal,” or “the same” may include a case of being “substantially parallel,” “substantially orthogonal,” or “substantially the same,” respectively.

In the present disclosure, a +X direction, a −X direction, a +Y direction, a −Y direction, a +Z direction, and a −Z direction are defined as described below.

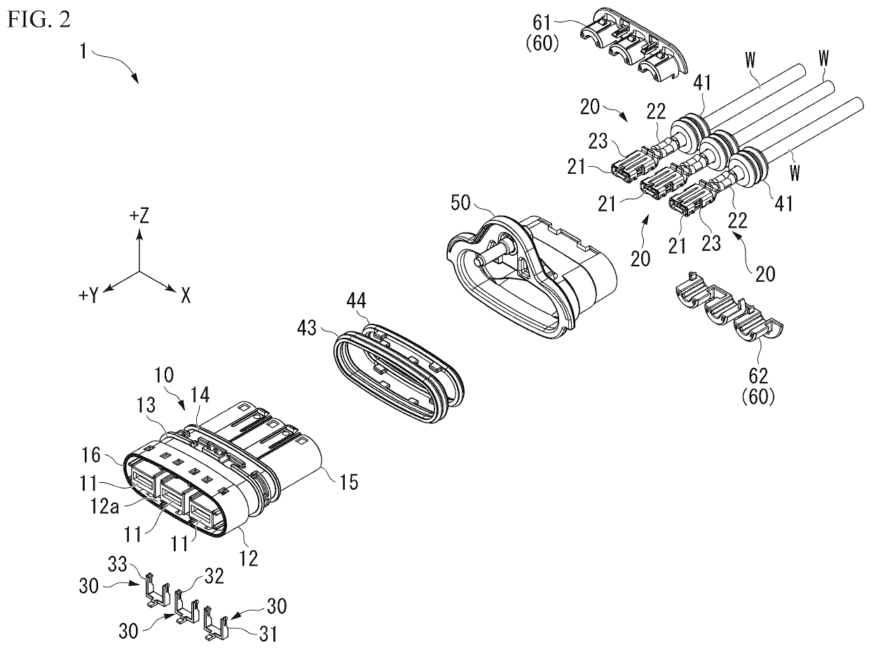

The +Y direction is a direction in which electric wires W are inserted into a housing 10 to be described below (see FIG. 2). The −Y direction is a direction opposite to the +Y direction, and is a direction in which the electric wires W come off from the housing 10. Hereinafter, when the +Y direction and the −Y direction are not distinguished, they are simply referred to as “Y direction”.

The +X direction is a direction orthogonal to the Y direction and in which proximal end portions 31 of spacers 30 to be described below extend (see FIG. 2). The −X direction is a direction opposite to the +X direction. Hereinafter, when the +X direction and the −X direction are not distinguished, they are simply referred to as “X direction”.

The +Z direction is a direction in which lock portions 32 and rib portions 33 to be described below extend (see FIG. 2). The −Z direction is a direction opposite to the +Z direction. Hereinafter, when the +Z direction and the −Z direction are not distinguished, they are simply referred to as “Z direction”.

In this embodiment, the Y direction is an example of a “first direction”. The Z direction is an example of a “second direction”. The X direction is an example of a “third direction”.

### Connector

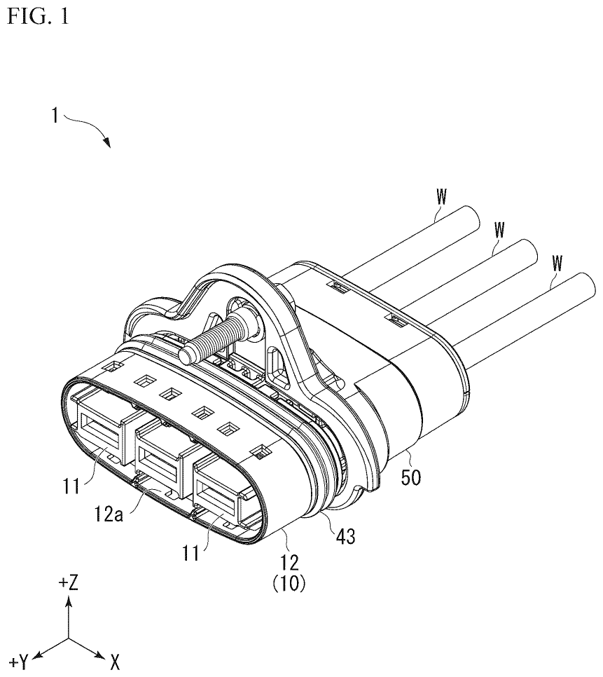

FIG. 1 is a perspective view illustrating a connector of the embodiment. FIG. 2 is an exploded perspective view illustrating the connector of the embodiment. In the figures, reference number 1 denotes a connector.

As illustrated in FIGS. 1 and 2, the connector 1 includes, for example, the housing 10, terminals 20, electric wires W, spacers 30, a cover portion 50, and an electric wire guide portion 60.

### Housing

The outer periphery of an end portion 15 of the housing 10 in the −Y direction is covered with the cover portion 50. An end portion of the housing 10 in the +Y direction is exposed. The end portion 16 of the housing 10 in the +Y direction has an oval and/or elliptical outer shape along an XZ plane.

The housing 10 is provided with a plurality of cavities 11. The cavity 11 has a through-hole penetrating the housing 10 in the Y direction. The terminals 20 are inserted into the cavities 11. The cavities 11 open at the end portion 16 of the housing 10 in the +Y direction. The insides of the cavities 11 are reduced in diameter so as to restrict the positions of the terminals 20 at the end portion 16 in the +Y direction. The cavity 11 has a cross-sectional shape corresponding to the outer shape of the terminal 20 when viewed in the Y direction.

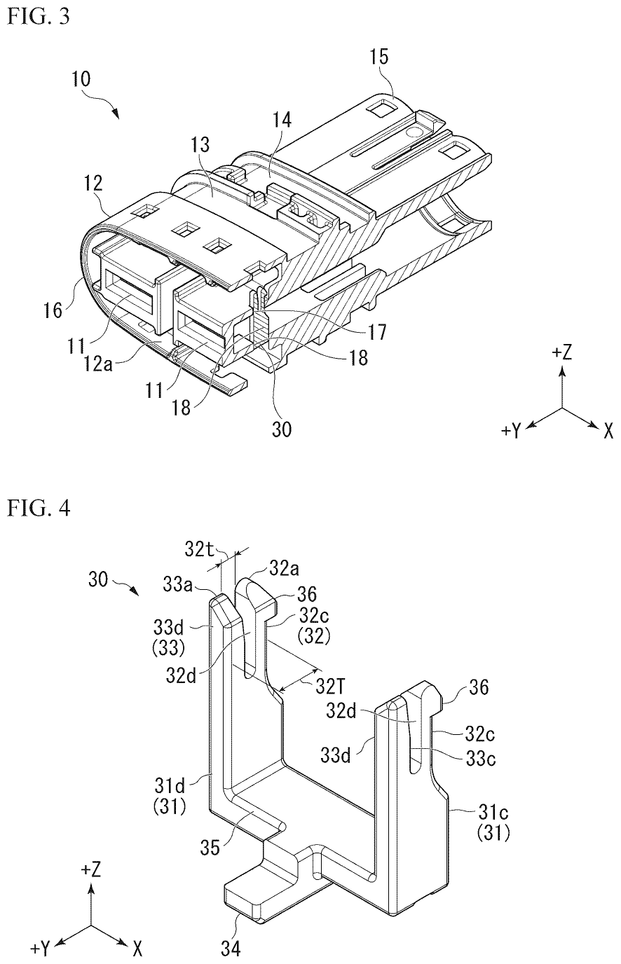

FIG. 3 is a perspective view illustrating the housing and the spacer of the connector of the embodiment in a partial cross-sectional view.

In the housing 10 of the present embodiment, three terminals 20 are inserted. The cavities 11 accommodate the terminals 20. The number of cavities 11 corresponds to the number of terminals 20. In the present embodiment, the number of the cavities 11 is three, but is not limited to this number. The number of terminals 20 may be singular. The number of cavities 11 may be singular. The three cavities 11 are arranged in the X direction. The three cavities 11 are separated from each other in the X direction. The three cavities 11 are parallel to each other.

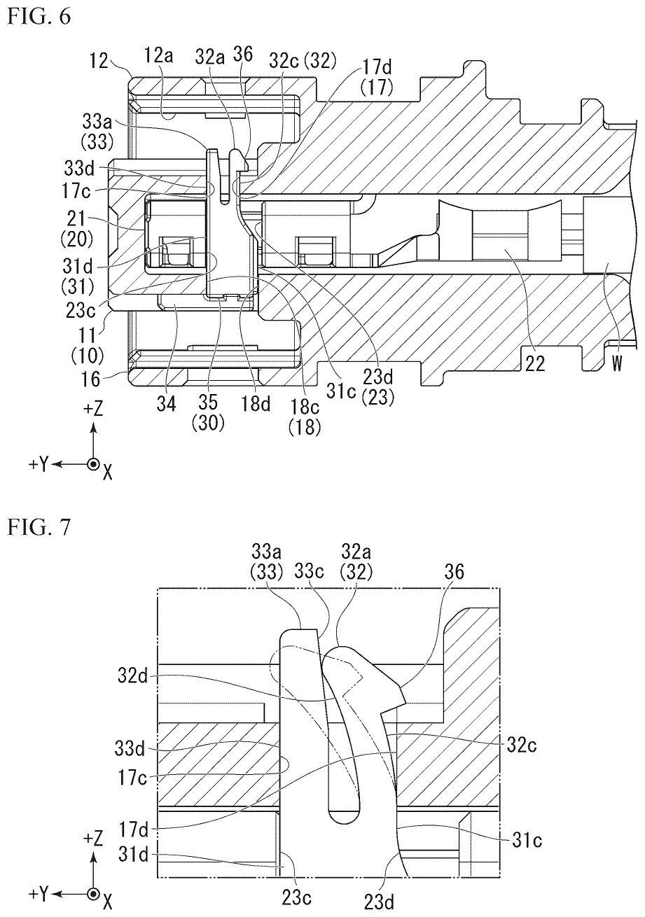

In the cavity 11, an upper fixing hole (fixing hole) 17 is formed on a surface in the +Z direction (see FIGS. 3 and 6). In the cavity 11, a lower fixing hole (fixing hole) 18 is formed on a surface in the −Z direction (see FIGS. 3 and 6). The upper fixing hole 17 and the lower fixing hole 18 penetrate the cavity 11 in the Z direction. The upper fixing hole 17 and the lower fixing hole 18 are both continuous with the inside of the cavity 11 and a groove portion 12a to be described below. The lock portion 32 and the rib portion 33 of the spacer 30 are inserted into the upper fixing hole 17. The proximal end portion 31 of the spacer 30 is inserted into the lower fixing hole 18.

The positions and shapes of the upper fixing hole 17 and the lower fixing hole 18 correspond to a notch 23 and the spacer 30 to be described below. The upper fixing hole 17 and the lower fixing hole 18 will be described below.

The housing 10 has a hood portion 12 at the end portion 16 in the +Y direction. The hood portion 12 surrounds the three cavities 11 when viewed in the Y direction. The hood portion 12 surrounds the end portion 16 of the housing 10 in the +Y direction over the entire circumference. The hood portion 12 is separated from all of the three cavities 11 when viewed in the Y direction. The groove portion 12a is formed between the hood portion 12 and the cavities 11. A female connector enters the groove portion 12a when the connector 1 is connected to a counterpart connector, which is not illustrated. The counterpart connector is joined to the groove portion 12a. As will be described below, a depth of the groove portion 12a in the Y direction is closer to the end portion 16 in the +Y direction with respect to the position of the end portion of the terminal 20 accommodated in the cavity 11 in the −Y direction. The depth of the groove portion 12a in the Y direction is closer to the end portion 16 in the +Y direction with respect to the spacer 30 to be described below. The hood portion 12, the cavities 11, and the groove portion 12a serve as guides for connecting the counterpart connector.

The housing 10 has a groove portion 13 and a groove portion 14 on the outer periphery in the −Y direction with respect to the hood portion 12. The groove portion 13 is continuous over the entire circumference of the housing 10 along a ZX plane. The groove portion 14 is also formed on the entire circumference of the housing 10. The groove portion 13 and the groove portion 14 are adjacent to each other in the Y direction. The groove portion 13 is adjacent to the groove portion 14 in the +Y direction. The groove portion 14 is located in the −Y direction with respect to the groove portion 13. A sealing ring 43 to be described below is fitted into the groove portion 13. A sealing ring 44 to be described below is fitted into the groove portion 14.

The housing 10 is formed such that the outer periphery in the-Y direction with respect to the groove portion 14 is smaller in outer diameter than the end portion 16 in the +Y direction.

The end portion of the housing 10 in the −Y direction is open. The opening at the end portion of the housing 10 in the −Y direction is continuous to the cavities 11. The outer shape of the end portion of the housing 10 in the −Y direction is smaller than the outer shape of the hood portion 12. The outer shape of the end portion of the housing 10 in the −Y direction in the ZX plane is smaller than the outer shape of the hood portion 12 in the XZ plane.

The outer periphery of the opening at the end portion of the housing 10 in the −Y direction is covered with the cover portion 50 to be described below. The electric wires W are inserted into the opening at the end portion of the housing 10 in the −Y direction via the cover portion 50 and sealing rings 41 to be described below.

### Terminal

The electric wires W are connected to the end portions of the terminals 20 in the −Y direction. The terminals 20 are connected to the end portions of the electric wires W in the +Y direction.

The terminal 20 includes a rectangular portion 21 and a connection portion 22. The rectangular portion 21 can be connected to a terminal of the counterpart connector. The connection portion 22 is connected to the electric wire W. The connection portion 22 is continuous with the rectangular portion 21 in the −Y direction.

The rectangular portion 21 has a rectangular ZX cross-sectional shape. The rectangular portion 21 is formed in a columnar shape having a rectangular cross section having an axis along the Y direction. For example, the rectangular portion 21 may be formed by bending a plate body around the axis. The rectangular portion 21 has a thickness along the Z direction smaller than a width along the X direction. The rectangular portion 21 and the connection portion 22 are formed of an electrically conductive material such as metal. The rectangular portion 21 has the same ZX cross-sectional shape over the entire length in the Y direction except for the notch 23 to be described below. The rectangular portion 21 has the same thickness along the Z direction over the entire length in the Y direction. The rectangular portion 21 has the same width along the X direction over the entire length in the Y direction except for the notch 23.

The length of the rectangular portion 21 in the Y direction is smaller than the length of the cavity 11 in the Y direction. The rectangular portion 21 is accommodated close to the end portion in the +Y direction inside the cavity 11. The rectangular portion 21 is accommodated inside the cavity 11 together with the connection portion 22. The length of the rectangular portion 21 in the X direction is slightly smaller than the length inside the cavity 11 in the X direction. The length of the rectangular portion 21 in the Z direction is slightly smaller than the length inside the cavity 11 in the Z direction.

The rectangular portion 21 has the notch 23 near the center in the Y direction. The notch 23 is formed at both side end portions of the rectangular portion 21 in the X direction. Both notches 23 have shapes symmetrical to each other in the X direction relative to the center of the rectangular portion 21. Each of the notches 23 is formed to reduce the width of the rectangular portion 21 along the X direction. The notch 23 may be formed by cutting out the plate body forming the outer shape of the rectangular portion 21. The notch 23 is formed in a rectangular shape when viewed in the Z direction.

The shape and position of the notch 23 correspond to the shapes and positions of the upper fixing hole 17, the lower fixing hole 18, and the spacer 30.

An end portion (end surface) 23c of the notch 23 in the +Y direction has a linear shape along the X direction when viewed in the Z direction. An end portion (end surface) 23d of the notch 23 in the −Y direction has a linear shape along the X direction when viewed in the Z direction. The notch 23 has the same width in the X direction over the entire length in the Z direction. The notch 23 has the same width in the Y direction over the entire length in the Z direction.

The width of the notch 23 in the X direction is equal to the length of the spacer 30 in the X direction to be described below. The width of the notch 23 in the X direction is equal to or slightly larger than the length of the proximal end portion 31 of the spacer 30 in the X direction to be described below (see FIG. 6).

In a state where the terminal 20 is inserted into the cavity, the end portion 23c of the notch 23 in the +Y direction coincides with an end portion (end surface) 17c of the upper fixing hole 17 in the +Y direction and an end portion (end surface) 18c of the lower fixing hole 18 in the +Y direction. That is, when viewed in the Z direction, the end portion 23c of the notch 23 in the +Y direction is at a position overlapping the end surface 17c of the upper fixing hole 17 in the +Y direction and the end surface 18c of the lower fixing hole 18 in the +Y direction. When viewed in the Z direction, the end portion 23c of the notch 23 in the +Y direction is at a position coinciding with an end portion (end surface) 31d of the proximal end portion 31 of the spacer 30 in the +Y direction to be described below and an end portion (end surface) 33d of the rib portion 33 in the +Y direction.

The end portion 23d of the notch 23 in the −Y direction coincides with an end surface 18d of the lower fixing hole 18 in the −Y direction in a state where the terminal 20 is inserted into the cavity. That is, when viewed in the Z direction, the end portion 23d of the notch 23 in the −Y direction is at a position coinciding with the end surface 18d of the lower fixing hole 18 in the −Y direction.

In a state where the terminal 20 is inserted into the cavity, the end portion 23d of the notch 23 in the −Y direction is at a position closer to the end portion 15 in the −Y direction with respect to an end portion (end surface) 17d of the upper fixing hole 17 in the −Y direction.

The width of the notch 23 in the X direction is equal to or slightly larger than the lengths of the lock portion 32 and the rib portion 33 of the spacer 30 in the X direction to be described below.

### Spacer

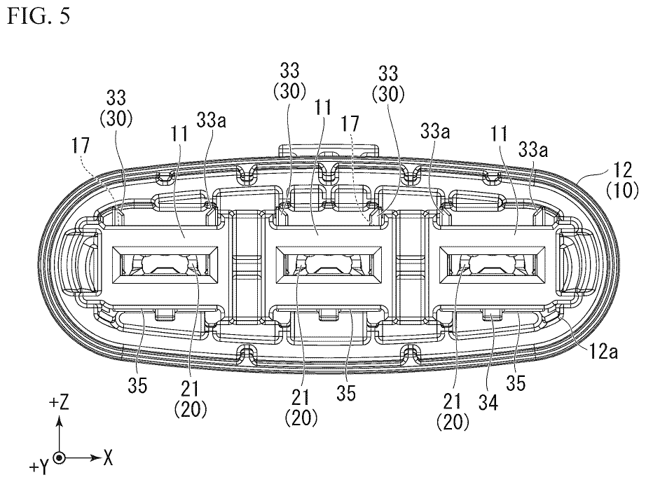

FIG. 4 is a perspective view illustrating the spacer of the connector of the embodiment. FIG. 5 is a front view illustrating the connector of the embodiment. FIG. 6 is a cross-sectional view along a YZ plane illustrating the connector of the embodiment. The spacer 30 includes the proximal end portions 31, the lock portions 32, the rib portions 33, an operation portion 34, and a lower beam 35. The spacer 30 is an elastic member. The spacer 30 is elastically deformable. The spacer 30 is formed of, for example, an elastic material such as resin. In the spacer 30, the proximal end portions 31, the lock portions 32, the rib portions 33, the operation portion 34, and the lower beam 35 are integrally formed. The spacer 30 is a terminal locking resin spacer.

The lower beam 35 extends in the X direction. The lower beam 35 has the operation portion 34 protruding in the +Y direction near the center in the X direction. The lower beam 35 has a rectangular YZ cross section except for the operation portion 34.

The length of the lower beam 35 in the X direction is the same as the length of the inside of the cavity 11 in the X direction and the length of the rectangular portion 21 in the X direction. The proximal end portion 31 is connected to each of both ends of the lower beam 35 extending in the X direction. The length of the lower beam 35 in the Y direction is the same as the length of the lower fixing hole 18 in the Y direction and the length of the notch 23 in the Y direction. The length of the lower beam 35 in the Y direction is equal over the entire length of the lower beam 35 along the X direction except for the operation portion 34.

Two proximal end portions 31 are provided in one spacer 30. Each of the proximal end portions 31 extends in the Z direction. The proximal end portions 31 rise in the +Z direction from both end portions of the lower beam 35 in the X direction. In each of the proximal end portions 31, an end portion in the −Z direction is connected to the lower beam 35. The two proximal end portions 31 have a symmetrical shape relative to the center of the lower beam 35 in the X direction. A distance in the X direction by which the two proximal end portions 31 are separated from each other is equal to the length of the rectangular portion 21 in the X direction. The two proximal end portions 31 sandwich the rectangular portion 21 in the X direction.

The length of the proximal end portion 31 in the X direction is the same as the length of the upper fixing hole 17 in the X direction and the length of the notch 23 in the X direction. The length of the proximal end portion 31 in the X direction is the same as the length of the lock portion 32 in the X direction and the length of the rib portion 33 in the X direction.

The length of the proximal end portion 31 in the Y direction is larger than the length of the proximal end portion 31 in the X direction. The proximal end portion 31 has a plate shape. The length of the proximal end portion 31 in the Y direction is the same as the length of the lower beam 35 in the Y direction. The length of the proximal end portion 31 in the Y direction is the same as the length of the lower fixing hole 18 in the Y direction and the length of the notch 23 in the Y direction. The length of the proximal end portion 31 in the Y direction is uniform at a position in contact with the lower fixing hole 18 in the Z direction. The vicinity of the end portion of the proximal end portion 31 in the −Z direction is in contact with the lower fixing hole 18. The length of the proximal end portion 31 in the Y direction is smaller at the end portion in the +Z direction than at the end portion in the −Z direction.

Each of the proximal end portions 31 has a rectangular XY cross section. In the proximal end portion 31, an end portion (end surface) 31c in the −Y direction and an end portion (end surface) 31d in the +Y direction are parallel to each other. In the proximal end portion 31, the end surface 31c in the −Y direction and the end surface 31d in the +Y direction are along the YZ plane. In the proximal end portion 31, both the end surface 31c in the −Y direction and the end surface 31d in the +Y direction coincide with the end portions of the lower beam 35 in the Y direction.

The end portion of the proximal end portion 31 in the +Z direction is connected to the lock portion 32 and the rib portion 33.

The lock portion 32 and the rib portion 33 are provided as a set on one proximal end portion 31. A set of the lock portion 32 and the rib portion 33 is provided on one proximal end portion 31. That is, two sets of the lock portion 32 and the rib portion 33 are provided in one spacer 30. The sets of the lock portion 32 and the rib portion 33 are separated from each other in the X direction. The sets of the lock portion 32 and the rib portion 33 sandwich the rectangular portion 21 in the X direction. The distance in the X direction by which the sets of the lock portion 32 and the rib portion 33 are separated from each other is equal to the length in the X direction between the notches 23 located on both sides of the rectangular portion 21.

The lock portion 32 and the rib portion 33 extend in the Z direction. The lock portion 32 and the rib portion 33 are parallel to each other. The lock portion 32 and the rib portion 33 are arranged in the Y direction. The lock portion 32 and the rib portion 33 are separated from each other in the Y direction. Both the lock portion 32 and the rib portion 33 extend in the +Z direction from the end portion of the proximal end portion 31 in the +Z direction. The lock portion 32 and the rib portion 33 pass through the upper fixing hole 17 at positions arranged along the Y direction.

The lock portion 32 is disposed at a position closer to the end portion 15 in the −Y direction than the rib portion 33 is. The lock portion 32 is disposed at a position close to the end portion 15 in the −Y direction at the end portion of the proximal end portion 31 in the +Z direction. The lock portion 32 is connected to the proximal end portion 31 at a position separated from the rib portion 33 in the −Y direction.

The lock portion 32 passes through the upper fixing hole 17. A distal end 32a of the lock portion 32 protrudes in the +Z direction beyond the upper surface of the cavity 11 in the +Z direction. The lock portion 32 has a convex portion 36 in the vicinity of the distal end 32a. The convex portion 36 protrudes in the −Y direction. The width of the lock portion 32 in the −Y direction is increased by the convex portion 36 in the vicinity of the distal end 32a. The lock portion 32 has a rectangular XY cross-sectional shape except for the convex portion 36. The lock portion 32 has a columnar shape in which the convex portion 36 protrudes in the −Y direction. The lock portion 32 has the same XY cross-sectional shape over the entire length in the Z direction except for the convex portion 36.

In the lock portion 32, an end portion (end surface) 32c in the −Y direction closer to the proximal end portion 31 than the convex portion 36 is and an end portion (end surface) 32d in the +Y direction are parallel to each other. In the lock portion 32, the end surface 32c in the −Y direction closer to the proximal end portion 31 than the convex portion 36 is and the end surface 32d in the +Y direction are along the YZ plane. The end surface 32c of the lock portion 32 in the −Y direction is closer to the rib portion 33 in the Y direction than the end surface 31c of the proximal end portion 31 in the −Z direction is.

The convex portion 36 protrudes in the −Y direction beyond the end surface 32c in the −Y direction. The convex portion 36 is formed such that a surface in the −Z direction is a plane along an XY plane. The convex portion 36 is at a position in the Z direction where the surface in the −Z direction is in contact with the upper surface of the cavity 11 in the +Z direction.

The rib portion 33 is disposed at a position closer to the end portion 16 in the +Y direction than the lock portion 32 is. The rib portion 33 passes through the upper fixing hole 17. A distal end 33a of the rib portion 33 protrudes in the +Z direction beyond the upper surface of the cavity 11 in the +Z direction as illustrated in FIG. 5. Unlike the lock portion 32, the rib portion 33 is not provided with the convex portion 36. The rib portion 33 has a rectangular XY cross-sectional shape. The rib portion 33 has the same XY cross-sectional shape over the entire length in the Z direction. The rib portion 33 is a lock arm deflection prevention rib.

The rib portion 33 is formed such that the end surface 33d in the +Z direction is a plane along the XY plane. The rib portion 33 is formed such that an end portion (end surface) 33c in the −Z direction is a plane along the XY plane. In the rib portion 33, the end surface 33c in the −Y direction and the end surface 33d in the +Y direction are parallel to each other.

The distal end 33a of the rib portion 33 is located at the same position as the distal end 32a of the lock portion 32 in the Z direction. The proximal end of the rib portion 33 is connected to the end portion of the proximal end portion 31 in the +Z direction at the same position as the proximal end of the lock portion 32 in the Z direction. The end surface 33d of the rib portion 33 in the +Z direction is flush with the end surface 31d of the proximal end portion 31 in the +Z direction.

The end surface 32c of the lock portion 32 in the −Y direction and the end surface 33d of the rib portion 33 in the +Y direction are parallel to each other. In the Y direction, a distance 32T between the end surface 32c of the lock portion 32 in the −Y direction and the end surface 33d of the rib portion 33 in the +Y direction is the same as the distance of the upper fixing hole 17 in the Y direction. In the Y direction, a distance between the end surface 33d of the rib portion 33 in the +Y direction and the convex portion 36 is larger than the distance of the upper fixing hole 17 in the Y direction.

In the Y direction, a distance 32t between the end surface 32d of the lock portion 32 in the +Y direction and the end surface 33c of the rib portion 33 in the −Y direction is equal to or larger than the length of the protrusion of the convex portion 36 from the end surface 32c in the −Y direction. The distance 32t is a separation distance in the X direction between the end surface 32d of the lock portion 32 in the +Y direction and the end surface 33c of the rib portion 33 in the −Y direction. The distance 32t corresponds to the separation distance in the X direction between the lock portion 32 and the rib portion 33. The protrusion length of the convex portion 36 in the Y direction is equal to or smaller than the separation distance 32t between the lock portion 32 and the rib portion 33.

The separation distance 32t is larger at a position close to the distal end 32a of the lock portion 32 and the distal end 33a of the rib portion 33 than at a position close to the proximal end portion 31 in the Z direction.

### Cover Portion

The cover portion 50 covers a portion close to the end portion 15 of the housing 10. The end portion 15 of the housing 10 is inserted into the cover portion 50 in the −Y direction. The ZX cross-sectional shape of the cover portion 50 surrounds the ZX cross-sectional shape profile in the vicinity of the end portion 15 of the housing 10. An end portion of the cover portion 50 in the −Y direction is substantially equal to the end portion 15. An end portion of the cover portion 50 in the +Y direction reaches the vicinity of the groove portion 14. The end portion of the cover portion 50 in the +Y direction sandwiches the sealing ring 44 with the outer periphery of the housing 10.

### Electric Wire

The electric wires W are electrically connected to the rectangular portions 21 via the connection portions 22. The sealing rings 41 are attached to the electric wires W at a position close to the connection portions 22. The sealing ring 41 is attached to each electric wire W. The sealing rings 41, the sealing ring 43, and the sealing ring 44 are sealing members. The sealing members are formed of, for example, waterproof rubber. The sealing members shield the insides of the cavities 11.

The sealing rings 41 are accommodated in the electric wire guide portion 60.

### Electric Wire Guide Portion

The electric wire guide portion 60 includes an upper guide portion 61 and a lower guide portion 62. The upper guide portion 61 covers the three sealing rings 41 from the +Z direction. The lower guide portion 62 covers the three sealing rings 41 from the −Z direction. The upper guide portion 61 and the lower guide portion 62 sandwich the three sealing rings 41 in the Z direction, and the electric wire guide portion 60 is inserted into the housing 10 in the +Y direction in a state where the sealing rings 41 are sandwiched. The electric wire guide portion 60 is inserted into the housing 10 simultaneously with the terminals 20. In a state where the electric wire guide portion 60 is inserted into the housing 10, the outer periphery of the housing 10 is covered with the cover portion 50.

FIG. 7 is a cross-sectional view illustrating an operation of the spacer of the connector of the embodiment.

As illustrated in FIG. 2, in the connector 1, the electric wires W, the sealing rings 41, the upper guide portion 61, the lower guide portion 62, the sealing ring 43, the sealing ring 44, the cover portion 50, and the housing 10 are assembled.

At the time of assembly, the terminals 20 are each inserted into the cavities 11 of the housing 10 in the +Y direction. The terminals 20 are moved in the +Y direction. The end portions of the terminals 20 in the +Y direction are accommodated up to a position close to the end portions in the +Y direction inside the cavities 11. At the accommodation position of the terminals 20, the position of the notches 23 in the Y direction coincide with the upper fixing holes 17 and the lower fixing holes 18 inside the cavities 11. The end portions 23c of the notches 23 in the +Y direction coincide with the end surfaces 17c of the upper fixing holes 17 in the +Y direction and the end surfaces 18c of the lower fixing holes 18 in the +Y direction. The end portions 23c, the end surfaces 17c, and the end surfaces 18c are flush with each other.

Further, the spacers 30 are inserted into the lower fixing holes 18 such that the distal ends 32a of the lock portions 32 and the distal ends 33a of the rib portions 33 face the +Z direction. Further, the spacers 30 are moved in the +Z direction to insert the distal ends 32a of the lock portions 32 and the distal ends 33a of the rib portions 33 into the upper fixing holes 17.

When the convex portions 36 pass through the upper fixing holes 17, the lock portions 32 are elastically deformed so as to bend in the +Y direction. After the convex portions 36 pass through the upper fixing holes 17, the lock portions 32 return to the original shape. Then, the surfaces of the convex portions 36 in the −Z direction are in contact with the upper surfaces of the cavities 11 in the +Z direction. The convex portions 36 are in a state of being locked to the cavities 11.

At the same time, the lower beams 35 are in the lower fixing holes 18 and are in contact with the upper surfaces of the cavities 11 in the −Z direction. The positions of the spacers 30 in the Z direction are fixed at a position where the surfaces of the convex portions 36 in the −Z direction are in contact with the upper surfaces of the cavities 11 in the +Z direction. The spacers 30 are fixed by the convex portions 36.

At the same time, the end surfaces 33d of the rib portions 33 in the +Y direction coincide with the end surfaces 17c of the upper fixing holes 17 in the +Y direction and the end surfaces 18c of the lower fixing holes 18 in the +Y direction. That is, the end surfaces 33d, the end portions 23c, the end surfaces 17c, and the end surfaces 18c are flush with each other. The end surfaces 33d are in contact with the end surfaces 17c. With the constitution in which the aforementioned surfaces are in contact with each other, the positions of the spacers 30 in the Y direction are defined by the upper fixing holes 17 and the lower fixing holes 18.

The end surfaces 31d of the proximal end portions 31 in the +Y direction coincide with the end surfaces 17c of the upper fixing holes 17 in the +Y direction, the end portions 23c of the notches 23 in the +Y direction, and the end surfaces 18c of the lower fixing holes 18 in the +Y direction. The end surfaces 31d are in contact with the end portions 23c. The end surfaces 31d are flush with the end surfaces 18c. Since the end surfaces 18c are flush with the end portions 23c of the notches 23 in the +Y direction, the positions of the end surfaces 31d in the Y direction coincide with those of the end portions 23c. That is, the end surfaces 31d, the end portions 23c, the end surfaces 17c, and the end surfaces 18c are flush with each other. The end surfaces 31d are in contact with the end surfaces 18c.

In addition, the end surfaces 32c of the lock portions 32 in the −Y direction coincide with the end surfaces 17c of the upper fixing holes 17 in the +Y direction. At the same time, the end surfaces 31c of the proximal end portions 31 in the −Y direction coincide with the end portions (end surfaces) 18d of the lower fixing holes 18 in the −Y direction. The end surfaces 32c are in contact with the end surfaces 17c. The end surfaces 31c are in contact with the end surfaces 18c.

With the constitution in which the aforementioned surfaces are in contact with each other, the positions of the spacers 30 in the Y direction are defined by the upper fixing holes 17 and the lower fixing holes 18. Similarly, with the constitution in which the aforementioned surfaces are in contact with each other, the positions of the terminals 20 in the Y direction are defined by the spacers 30.

In the connector 1 of the embodiment, in the assembling order, the terminals 20 are fixed to the housing 10 by inserting the terminals 20 into the housing 10 and then assembling the spacers 30. At this time, the spacers 30 are locked to the upper fixing holes 17 of the housing 10 by the convex portions 36 provided at the distal ends of the lock portions 32.

Next, a case where the terminal 20 is pulled in the −Y direction will be considered. The situation in which the terminal 20 is pulled can easily occur, for example, when the housing 10 is fixed and the electric wire W is pulled in the −Y direction.

First, the end portion 23c of the notch 23 of the terminal 20 in the +Y direction is in contact with the end surface 31d of the proximal end portion 31 in the +Y direction. When the terminal 20 is pulled in the −Y direction, the spacer 30 is pushed in the −Y direction from the terminal 20. Then, the lock portion 32 of the spacer 30 is pressed in the −Y direction against the end surface 17d of the upper fixing hole 17 in the −Y direction. At the same time, the proximal end portion 31 of the spacer 30 is pressed in the −Y direction against the end surface 18d of the lower fixing hole 18 in the −Y direction.

Since the lock portion 32 has a smaller length in the Y direction than the proximal end portion 31, the lock portion 32 is elastically deformed. The end surface 32c of the lock portion 32 in the −Y direction is pushed in the +Y direction from the end surface 17d of the upper fixing hole 17 in the +Y direction.

Then, as illustrated in FIG. 7, the distal end 32a of the lock portion 32 from the proximal end in the −Z direction is curved in the +Y direction. The distal end 32a of the lock portion 32 from the proximal end in the −Z direction is inclined in the +Y direction. The rib portion 33 exists in the +Y direction with respect to the lock portion 32. Accordingly, the distal end 32a of the lock portion 32 comes into contact with the end surface 33c of the rib portion 33 in the −Y direction.

The lock portion 32 the distal end 32a of which is in contact with the end surface 33c is not further deformed. That is, the moving distance of the distal end 32a in the +Y direction is not larger than the distance 32t. That is, the moving distance of the distal end 32a in the +Y direction can be limited to a range smaller than the distance 32t. The rib portion 33 acts as a deflection prevention portion with respect to the lock portion 32.

Since the moving distance of the distal end 32a is within the range smaller than the distance 32t, the lock portion 32 is not deformed to a position where the convex portion 36 is inclined in the +Y direction beyond the end surface 17d of the upper fixing hole 17 in the −Y direction. That is, the lock portion 32 is not deformed to a position where the convex portion 36 comes off from the upper fixing hole 17. The lock portion 32 maintains the locked state. Accordingly, the spacer 30 maintains a state of not coming off from the housing 10.

Moreover, in the spacer 30, two sets of the lock portion 32 and the rib portion 33 are provided at both ends in the X direction. Accordingly, only one lock portion 32 of the spacer 30 does not come off from the housing 10. The spacer 30 maintains a state of not coming off from the housing 10.

With this constitution, since the spacer 30 can maintain the locked state, even when the terminal 20 is pulled in the −Y direction, the terminal 20 does not come off from the cavity 11.

On the other hand, in the case of the conventional structure without the rib portion 33, the lock portion 32 is deformed to a position where the convex portion 36 comes off from the upper fixing hole 17 as indicated by the broken line in FIG. 7, so that the locked state may not be maintained.

### Operations and Effects

The connector 1 of the embodiment includes the housing 10 having the cavities (holes) 11 extending in the Y direction (first direction), the terminals 20 connected to the electric wires W and inserted into the cavities 11, and the spacers (locking members) 30 including the proximal end portions 31, the lock portions (lock arms) 32 extending from the proximal end portions 31 in the Z direction (second direction), and the rib portions (deflection prevention ribs) 33 arranged with the lock portions 32 in the Y direction and extending from the proximal end portions 31 in the Z direction. With this constitution, when the terminal 20 is pulled in the −Y direction when the electric wire W is pulled in the −Y direction, the lock portion 32 is pushed by the terminal 20 with respect to the cavity 11, and the distal end 32a is bent to be inclined in the +Y direction. Then, the lock portion 32 comes into contact with the rib portion 33 to restrict the deflection of the lock portion 32 while having the convex portion (engagement margin) 36 to be caught on the housing 10. The spacer 30 is less likely to come off from the housing 10. At the same time, the terminal 20 is less likely to come off from the housing 10.

In the connector 1 of the embodiment, the lock portion 32 is connected to the proximal end portion 31 at a position separated from the rib portion 33 in a direction in which the terminal 20 comes off from the cavity 11 in one direction. In other words, in the lock portion 32, the convex portion 36 is disposed on the opposite side to the rib portion 33 on the −Y direction side in which the electric wire W is pulled. That is, the load in the −Y direction, which is generated when the electric wire W is pulled or at the time of fitting to the counterpart connector terminal and by which the terminal 20 comes off, is not in the direction of reducing the catch of the lock portion 32. Accordingly, even when a force in the −Y direction is applied, the spacer 30 can firmly hold the terminal 20 without falling off from the housing 10. The terminal 20 is less likely to come off from the housing 10.

Further, the spacer 30 has two sets of the lock portion 32 and the rib portion 33 with the terminal 20 interposed therebetween in the X direction. With this constitution, the terminal 20 can be locked by the spacer 30 at both side positions of the terminal 20 in the X direction, so that the fixation of the terminal 20 is stabilized.

Further, the terminal 20 has the notch 23 recessed in a third direction intersecting the first direction and the second direction at a position corresponding to the set of the lock portion 32 and the rib portion 33. With this constitution, the spacer 30 can reliably lock the terminal 20, and the terminal 20 is less likely to come off from the housing 10.

In the connector 1 of the embodiment, the rib portion 33 that is a deflection prevention rib is provided at a position in the direction of deflection of the lock portion 32 due to the pulling of the electric wire W in the −Y direction. With this holding force-increasing structure, it is possible to suppress a decrease in the engagement margin of the lock portion 32 of the spacer 30 with respect to the housing 10 due to the pulling of the electric wire W in the −Y direction, that is, the length of the catch of the convex portion 36 in the −Y direction.

The lock portion 32 has the convex portion 36 that protrudes in a direction in which the terminal 20 comes off from the cavity 11 in the first direction and is engaged with the housing 10. Further, the convex portion 36 that holds the spacer 30 so as not to come off from the housing 10 is also used as a structure for locking the terminal 20. Accordingly, the number of parts can be reduced with a simple structure.

In the connector 1 of the embodiment, the protrusion length of the convex portion 36 is equal to or smaller than the separation distance 32t between the lock portion 32 and the rib portion 33 in the first direction. Further, the clearance between the upper fixing hole 17 and the spacer 30 is eliminated so that the engagement margin does not decrease due to the excessive deflection of the lock portion 32.

With this structure, even when the electric wire W is pulled in the −Y direction, the engagement margin of the lock of the spacer 30 is secured, and the unlocking and the falling off of the spacer 30 from the housing 10 can be prevented. It is difficult for the terminal 20 to come off from the housing 10.

In the connector 1 of the embodiment, the lock portion 32 and the rib portion 33 have the same length from the proximal end portion 31 to the distal end 32a and the distal end 33a in the second direction. Then, even when the electric wire W is pulled in the −Y direction and the lock portion 32 is bent in the +Y direction, the lock portion 32 reliably hits the end surface 33c of the rib portion 33 and it is possible to prevent the deformation of the lock portion 32 from increasing. Accordingly, when the electric wire W is pulled in the −Y direction at the time of assembling the vehicle or assembling the connector, the lock locked to the housing 10 is less likely to be released and the spacer 30 is less likely to fall off. The terminal 20 is less likely to come off from the housing 10.

The separation distance 32t between the lock portion 32 and the rib portion 33 is larger at a position close to the distal end portions 32a and 33a of the lock portion 32 and the rib portion 33 than at a position close to the proximal end portion 31 in the second direction. The lock portion 32 and the rib portion 33 can be easily inserted into the fixing hole 17, and the strength of the lock portion 32 and the rib portion 33 can be increased.

Several embodiments and modifications have been described above. However, the embodiment and the modification are not limited to the examples described above. For example, the embodiments can be implemented in various other forms, and the individual constitutions described above can be individually selected and implemented in combination, or various additions, omissions, substitutions, and changes can be made without departing from the gist of the present disclosure.

According to the present disclosure, the terminal is less likely to come off from the housing.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

### BRIEF DESCRIPTION OF THE REFERENCE SYMBOLS

1 Connector
10 Housing
11 Cavity (hole)
12 Hood portion
12a Groove portion
13, 14 Groove portion
15, 16 End portion
17 Upper fixing hole (fixing hole)
17c, 17d End portion (end surface)
18 Lower fixing hole (fixing hole)
18c, 18d End portion (end surface)
20 Terminal
21 Rectangular portion
22 Connection portion
23 Notch
23c, 23d End portion (end surface)
30 Spacer
31 Proximal end portion
31c, 31d End portion (end surface)
32 Lock portion
32a, 33a Distal end
32c, 32d End portion (end surface)
32t Separation distance
32T Distance
33 Rib portion
33c, 33d End portion (end surface)
34 Operation portion
35 Lower beam
36 Convex portion
41,43,44 Sealing ring
50 Cover portion
60 Electric wire guide portion
61 Upper guide portion
62 Lower guide portion
W Electric wire

What is claimed is:

1. A connector comprising:
a housing that includes a cavity extending in a first direction;
a terminal that is connected to an end portion of an electric wire and inserted into the cavity; and
a spacer that includes a proximal end portion, a lock portion extending from the proximal end portion in a second direction intersecting the first direction, and a rib portion disposed to be arranged in the first direction with the lock portion and extending from the proximal end portion in the second direction,
wherein the spacer has the lock portion engaged with the housing to restrict the movement of the terminal with respect to the housing in the first direction, and
the lock portion and the rib portion have relative positions at which the lock portion deflected in the first direction comes into contact with the rib portion to restrict deflection of the lock portion and maintain engagement with the housing.

2. The connector according to claim 1, wherein the lock portion is connected to the proximal end portion at a position separated from the rib portion in a direction in which the terminal comes off from the cavity in the first direction.

3. The connector according to claim 2, wherein the spacer has two sets of the lock portion and the rib portion at positions sandwiching the terminal.

4. The connector according to claim 2, wherein the lock portion has a convex portion that protrudes in a direction in which the terminal comes off from the cavity in the first direction and is engaged with the housing.

5. The connector according to claim 3, wherein the terminal has a notch recessed in a third direction intersecting the first direction and the second direction at a position corresponding to the set of the lock portion and the rib portion.

6. The connector according to claim 4, wherein a protrusion length of the convex portion is equal to or smaller than a separation distance between the lock portion and the rib portion in the first direction.

7. The connector according to claim 6, wherein the separation distance between the lock portion and the rib portion is larger at a position close to a distal end portion of the lock portion and the rib portion than at a position close to the proximal end portion in the second direction.

8. The connector according to claim 7, wherein the lock portion and the rib portion have an equal length from the proximal end portion to a distal end in the second direction.
